(19) United States
(12) Patent Application Publication
(10) Pub. No.: US 2008/0205553 A1
(43) Pub. Date: Aug. 28, 2008

(54) RECONSTRUCTION OF TIRE PRESSURE MONITORING SIGNALS

(75) Inventors: John R. Costello, Rochester Hills, MI (US); Jean-Christophe Deniau, Fenton, MI (US); Brian Farrell, Troy, MI (US)

Correspondence Address: SIEMENS CORPORATION;INTELLECTUAL PROPERTY DEPARTMENT, 170 WOOD AVENUE SOUTH, attn: VDO - CGO docketing migration, ISELIN, NJ, 08830, US

(73) Assignee: CONTINENTAL AUTOMOTIVE SYSTEMS US, INC., Auburn Hills, MI (US)

(21) Appl. No.: 12/035,497

(22) Filed: Feb. 22, 2008

Related U.S. Application Data
(60) Provisional application No. 60/904,155, filed on Feb. 27, 2007.

(51) Int. Cl. H04L 27/06

(52) U.S. Cl. 375/316

(57) ABSTRACT

A tire pressure monitoring system includes a process of reconstructing a complete data frame from portions of partially received data frames. The tire pressure monitoring system includes a receiver that includes a buffer to store portions of the transmissions for reconstruction of data in response to portions of the transmission not being received. A reconstructed data frame is generated using the saved partially received data frame and the currently received partial data frame.

### CROSS REFERENCE TO RELATED APPLICATION

The application claims priority to U.S. Provisional Application No. 60/906,697 all filed on Feb. 23, 2007.

### BACKGROUND OF THE INVENTION

This invention generally relates to method increasing signal robustness. More particularly, this invention relates to a method of reconstructing partially received data from a tire monitoring sensors with a receiver within a motor vehicle.

A system for transmitting signals from remote transmissions such as for example a tire pressure monitoring system for a motor vehicle transmits several identical repeated data frames for each pressure data point. The location and relative movement of the transmitter relative to the receiver can result in partially blocked portions of the transmission. The partially blocked portions can result in only a partial portion of any one data frame being received. The partial data frames are not useful and the receiver disregards the data contained therein.

Disadvantageously, the blocked out portion of a transmission can be such that it repeatedly blocks a portion of each data frame, resulting in the complete loss of data contained in a transmission. A repeated and cyclical failure to receive transmitted data may prevent communication of data that is required to make informed operating decisions.

Accordingly, it is desirable to design and develop a system and process for recovering data from partially blocked transmissions.

### SUMMARY OF THE INVENTION

An example a tire pressure monitoring system includes a process of reconstructing a complete data frame from portions of partially received data frames.

The example disclosed tire pressure monitoring system includes a receiver that processes transmissions from each of a plurality of tire pressure monitoring sensor transmitters. The receiver includes a buffer to store portions of the transmissions for reconstruction of data in response to portions of the transmission not being received. A reconstructed data frame is generated using the saved partially received data frame and the currently received partial data frame. Because the transmitted data frames are identical, the data can be reconstructed by checking for overlapping identical data. The overlapping identical data is utilized to align the saved partial frame with the received partial frame to create the combined and reconstructed data frame that is processed and utilized by the receiver.

Accordingly, the disclosed method and system provide for the recovery of partially received messages to decrease the possibility that data contained in any transmission is completely lost.

These and other features of the present invention can be best understood from the following specification and drawings, the following of which is a brief description.

### BRIEF DESCRIPTION OF THE DRAWINGS

FIG. 1 is a schematic view of a vehicle including a tire pressure monitoring system.

FIG. 2 is schematic view of sequence of transmission and reconstruction of several data frames.

### DETAILED DESCRIPTION OF THE PREFERRED EMBODIMENT

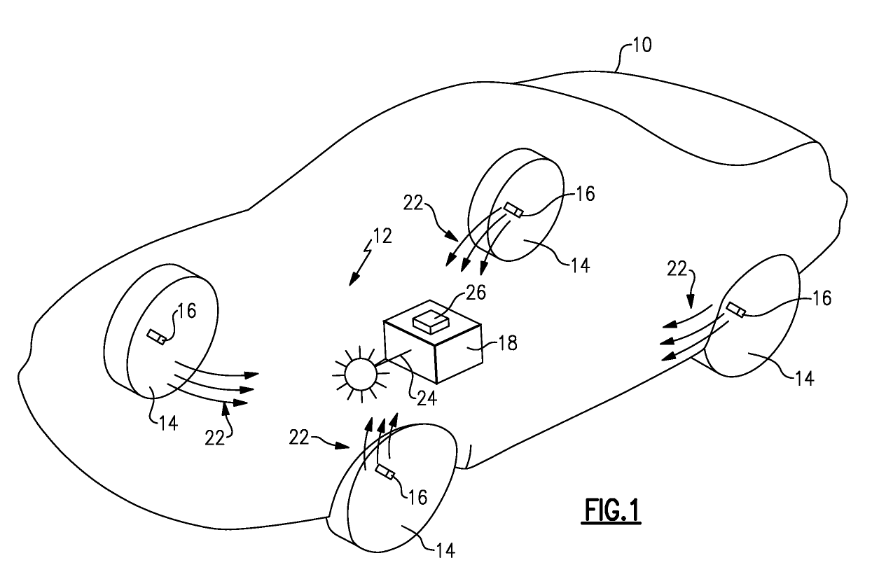

Referring to FIG. 1, a vehicle 10 includes a tire pressure monitoring system 12. The tire pressure monitoring system 12 includes a receiver 18 that processes transmissions 22 from each of a plurality of tire pressure monitoring sensor transmitters 16. Each tire 14 of the vehicle 10 includes a corresponding transmitter 16. The transmitters 16 rotate with the tires 14. The rotation of the tire 14 can generate blind spots where a portion of the transmission 22 is blocked. The example receiver 18 includes a buffer 26 to store portions of the transmissions 22 to provide for reconstruction of data in response to portions of the transmission being blocked.

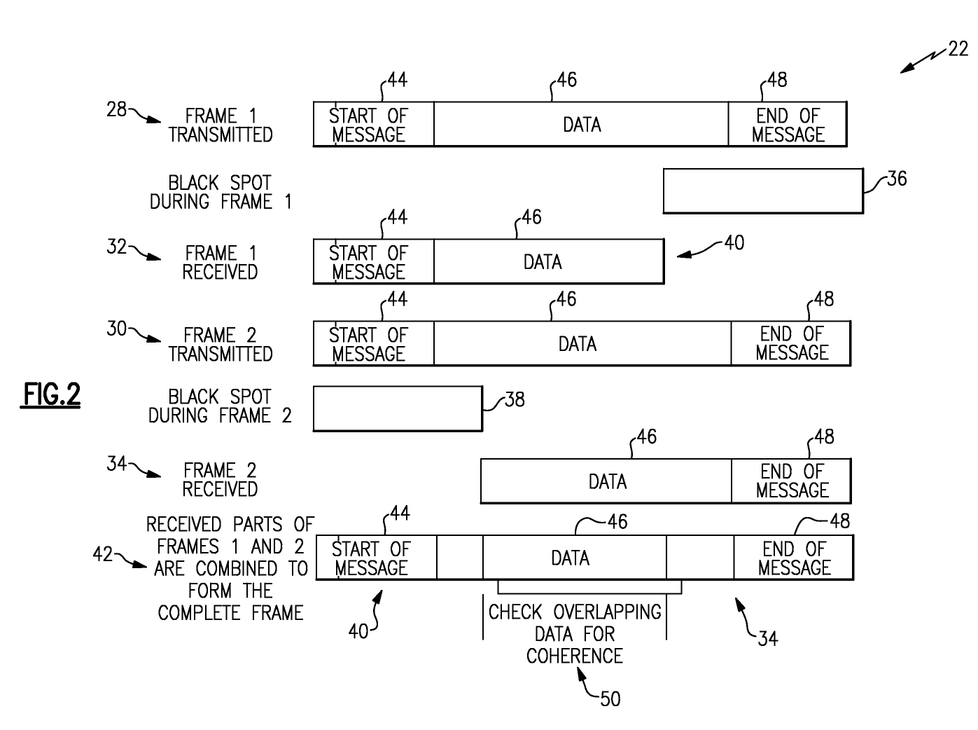

Referring to FIG. 2, with continued reference to FIG. 1, each transmission 22 includes several identical data frames. Each data frame includes a start of message sequence 44 and an end of message sequence 48. Between the start of message 44 and the end of message sequences 44, 48 is the data portion 46. Each transmission includes a plurality of these identical data frames. In some instances only a portion of any data frame is received. A partially received data frame is not useful. The example method includes a process of reconstructing a complete data frame from portions of partially received data frames.

A first data frame 28 is transmitted from one of the transmitters 16 and is partially blocked as indicated at 36. The receiver 18 receives only a partial portion of the transmitted data frame as indicated at 32 that includes the start message 44 sequence followed by some of data, but no end of message sequence 48. Upon receipt of the partial data frame 32, the receiver 18 saves that data in the buffer 26. In the disclosed example, the receiver 18 saves all data that is received that falls within a defined transmission data rate range. The saved data is not decoded or otherwise processed; it is simply saved for latter processing if required.

A second data frame 30 is transmitted and is partially blocked as is schematically indicated at 38. The blocked portion results in on a partial portion of the data frame as indicated at 34 being received. The second partial portion includes portions of the data and the end message sequence 48. In response to the receipt of the partial data frame 34 including the end of message sequence 48 without a corresponding start of message sequence 44, the receiver 18 begins decoding the buffered data frame 32. The buffered data frame 32 includes the start message sequence 44 and a beginning portion of the data 46. The currently received partial data frame includes the back end of the data the end of message sequence 48. Together, the saved data frame 32 and the currently received partial data frame 34 comprise an entire message.

A reconstructed data frame 42 can be generated using the saved partial saved data frame 32 and the currently received partial data frame. Because the transmitted data frames 28 and 30 are identical, the data 46 can be reconstructed by checking for overlapping identical data. The overlapping identical data 46 is utilized to align the saved partial frame 32 with the received partial frame to create the combined and reconstructed data frame 42 that is processed and utilized by the receiver 18.

In the event that a complete data frame is received after a portion of data is saved, that data is simply disregarded. The buffer is then replaced with subsequent data frames until needed. In other words the data within the buffer is rotated to reflect the last received data frame or portions of that data frame. The receiver 18 is thereby prepared to recreate data frames if required and prompted by a received incomplete data frame including an end of message sequence 48 without a corresponding start of message sequence 44.

As should be understood, the described example utilizes the receipt of an end of message sequence 48 without a corresponding start of message sequence 44 to prompt the combination of saved and currently received data. However, other prompts that are indicative of receipt of an incomplete data frame, such as receipt of the start message sequence 44 without a corresponding end of message sequence 48 could also be utilized. Further, other portions and indications of incomplete receipt of a data frame could be utilized such as for example data frame length.

Accordingly, the disclosed method and system provide for the recovery of partially received messages to decrease the possibility that data contained in any transmission is completely lost.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of reconstructing incomplete data between a transmitter and a receiver comprising the steps of:
a) transmitting a signal from a transmitter that includes a plurality of data frames including a start message and an end message;
b) saving portions of the received signals; and
c) combining portions of the saved signals with subsequently received signals responsive to receiving incomplete portions of at least two of the plurality of data frames

2. The method as recited in claim 1, wherein the saved signals are combined with portions of the saved signals responsive to receipt of an end message without a corresponding start message for any one of the plurality of data frames.

3. The method as recited in claim 2, wherein the step of combining portions of the saved signals with subsequent ones includes decoding the saved portions of the received signals and combining the saved portions with received portions to create a complete data frame.

4. The method as recited in claim 2, including the step of disregarding the saved portions of the received signals responsive to receipt of a start message.

5. The method as recited in claim 1, including the step of saving received signals having a data rate common to a known data rate of a signal from the transmitter.

6. The method as recited in claim 1, wherein the step of saving the received signals comprises buffering consecutive edge intervals of an incoming signal that are within a selected data rate tolerance band.

7. The method as recited in claim 1, including combining portions of the saved signals with subsequently received signals and checking overlapping data to determine coherence of the created data frame.

8. A method of creating a complete data frame for a tire pressure monitoring system comprising the steps of:
a) sending a plurality of data frames including data indicative of conditions within a tire that includes a start portion indicating the beginning of a data frame and an end portion indicating an end of a data frame;
b) saving portions of incoming data frames in a coded condition; and
c) combining the saved portions of incoming data with subsequently received data frames responsive to receiving an end portion without receiving a corresponding start portion.

9. The method as recited in claim 8, including the step of decoding the saved portions of incoming data frames responsive to receiving the end portion without the corresponding start portion.

10. The method as recited in claim 8, including the step of matching the saved portions with the subsequently received portions to create a complete one of the plurality of data frames.

11. The method as recited in claim 10 including the step of matching data points of the saved portions of data with received portions to determine where to combine the saved portions of data with the received portions of data.

12. The method as recited in claim 8 wherein the saved portions of incoming data frames is disregarded responsive to receipt of a start portion of an incoming data frame.

13. The method as recited in claim 8, including the step of saving portions of data that correspond with a desired data transfer rate of the transmitter.

14. The method as recited in claim 8, wherein the transmitter sends a plurality of identical data frames for each pressure that is transmitted.

15. A tire pressure monitoring system comprising:
At least one transmitter generating a signal indicative of a pressure within a tire, wherein each of the signals include a plurality of identical data frames each including a start portion indicating the beginning of one of the plurality of data frames and an end portion indicating an end of a data frame; and
a receiver including a buffer for saving portions of incoming signals; the receiver combining saved portions of the incoming signals responsive to receiving the end portion without receiving a corresponding start portion.

16. The system as recited in claim 15, wherein the receiver does not decode the saved portions until combined with a received message including an end portion without a start portion.

17. The system as recited in claim 15, wherein the receiver saves portions of incoming signals comprising a data transmission rate with a desired range.

18. The system as recited in claim 15, wherein the saved portions of the incoming signals are disregarded responsive to receiving a start signal.
